(19) United States
(12) Patent Application Publication
(10) Pub. No.: US 2015/0056543 A1
(43) Pub. Date: Feb. 26, 2015

(54) Sublimation Transfer Dyeing Method And Dyed Product Thereby

(71) Applicants: Nippon Kayaku Kabushiki Kaisha, Chiyoda-ku, Tokyo (JP); Etowas Co., Ltd., Higashiosaka-shi, Osaka (JP)

(72) Inventors: Yuji Suzuki, Kita-ku (JP); Makoto Teranishi, Kita-ku (JP); Hirokazu Kitayama, Kita-ku (JP); Yoshihiro Takai, Higashiosaka-shi (JP); Kousuke Takai, Higashiosaka-shi (JP)

(21) Appl. No.: 14/384,219

(22) PCT Filed: Mar. 13, 2013
(86) PCT No.: PCT/JP2013/057006

§ 371 Date: Sep. 10, 2014

(30) Foreign Application Priority Data
Mar. 16, 2012 (JP) 2012-060739

(51) Int. Cl. D06P 5/28; G03G 13/22

(52) U.S. Cl. CPC D06P 5/004; G03G 13/22
USPC 430/9; 430/124.12; 430/111.1

(57) ABSTRACT

[Problem] To provide a sublimation transfer dyeing method capable of highly efficient dyeing of a product to be dyed by an electrophotographic process using a toner, and a dyed product dyed highly efficiently by the dyeing method.

[Solution] A sublimation transfer dyeing method attaches a toner to an intermediate recording medium using an electrophotographic process and sublimation-transfers to a dyed product a dye contained in the toner attached to the intermediate recording medium. A dyed product dyed with high efficiency could be provided by a sublimation transfer dyeing method in which the intermediate recording medium has a density of greater than 1.00 g/cm³.

### TECHNICAL FIELD

The present invention relates to a sublimation transfer dyeing method for dyeing a product to be dyed using an intermediate recording medium applied with a sublimation transfer toner, and a dyed product obtained using the dyeing method.

### BACKGROUND ART

Dyeing methods using electrophotographic processes for dyeing hydrophobic fiber typified by polyester fabric or hydrophobic resin typified by PET film can be largely classified into two methods.

Specifically, there are direct methods in which toner is directly applied to a product to be dyed and a dye contained in the toner is then attached to the product to be dyed by thermal treatment; and sublimation transfer methods in which a toner is applied to a paper or other intermediate recording medium, the toner-applied surface of the intermediate recording medium is then overlaid on a product to be dyed, thermal treatment is then performed, and a dye contained in the toner is sublimation-transferred to the product to be dyed.

Of these two methods, the sublimation transfer method is considered appropriate for dyeing for uses emphasizing texture, such as sports apparel and other clothing. The dye in the toner used in the sublimation transfer method is a disperse dye or an oil-soluble dye that is suitable for dyeing of hydrophobic fiber, and particularly an easily sublimated type of dye that has excellent suitability for sublimation transfer to hydrophobic fiber by thermal treatment.

When the sublimation transfer method is used in electrophotography, it is possible to attach only the dye among a plurality of ingredients constituting the toner to the fiber from the intermediate recording medium. As a result, the ingredients constituting the toner other than the dye are not attached to the cloth to be dyed, and advantages are obtained, including that the method is optimal for uses emphasizing texture of cloth, for example, clothing; seats, sofas, and other interior furnishings; or bedding; and also that the risk of occurrence of rashes, eczema, or the like, due to the ingredients constituting the toner in persons having sensitive skin quality can be reduced.

Unnecessity of washing and drying processes and the like brings advantages including great abridgment of the dyeing process; elimination of the need for washing and drying lines, wash water treatment equipment, and the like, which are highly costly and require large-scale space and large-scale operating energy.

Accordingly, the sublimation transfer method is considered as an excellent dyeing method that enables dyeing even in small-scale spaces.

Meanwhile, inkjet methods are generally considered to be the mainstream as means for dyeing fiber by the sublimation transfer method.

However, in sublimation transfer dyeing using the inkjet method, there are problems including that an organic solvent as one ingredient constituting an ink volatizes due to heat during transfer of the dye and contaminates the work environment.

As opposed to this, electrophotographic methods are attracting attention lately for reasons including that no volatile ingredients are present in the toner and thus the work environment is not contaminated; the size of fiber (or cloth, or the like, being a structure thereof) that can be dyed is now applicable to the field of sports apparel due to the appearance of a photosensitive drum capable of output up to 900 mm width; and the dyed area per unit time is larger compared with the inkjet method (serial printing method).

Sublimation transfer dyeing methods using electrophotographic processes are disclosed, for example, in patent references 1 to 5 below.

Meanwhile, a characteristic of electrophotographic processes is that even when toner is applied to paper as an intermediate recording medium, the toner remains on the paper surface and does not penetrate to the inside of the paper. Therefore, even though it has become possible to use inexpensive common paper as an intermediate recording medium rather than using special paper such as for inkjet, in a sublimation transfer dyeing method in an electrophotographic process in an experiment according to the present invention, it was confirmed that dyed cloth can be sublimation transfer dyed with high efficiency by using a special paper as an intermediate recording medium for electrophotography.

### PRIOR ART REFERENCES

### Patent References

Patent Reference 1: Japanese Laid-Open Patent Application 02-295787

Patent Reference 2: Japanese Laid-Open Patent Application 06-051591

Patent Reference 3: Japanese Laid-Open Patent Application 10-058638

Patent Reference 4: Japanese Laid-Open Patent Application 2000-029238

Patent Reference 5: Japanese Laid-Open Patent Application 2006-500602

### SUMMARY OF THE INVENTION

### Problems to be Solved by the Invention

An object of the present invention is to provide a sublimation transfer dyeing method that is capable of highly efficient dyeing of a product to be dyed by an electrophotographic process using a toner, and a dyed product dyed highly efficiently using the dyeing method.

### Means Used to Solve the Above-Mentioned Problems

The present inventors completed the present invention, having discovered as a result of carrying out devoted research in order to achieve the aforementioned object, that the aforementioned object can be achieved by using a paper having a specific density as an intermediate recording medium. Specifically, the present invention relates to the following (1) to (13).
(1) A sublimation transfer dyeing method, comprising:
   attaching a toner to an intermediate recording medium using an electrophotographic process, and
   sublimation-transferring, to a product to be dyed, a dye contained in the toner attached to the intermediate recording medium,
      wherein an intermediate recording medium having a density greater than 1.00 g/cm³ is used as the intermediate recording medium.
(2) The sublimation transfer dyeing method according to (1), wherein the intermediate recording medium is paper selected from the group consisting of paper listed in JIS P 0001:1998 3. classification f) varieties and processed products of paper and paperboard; and cellophane listed in JIS Z 0108:2005 3. classification b) packaging material 1) paper and paperboard-related.
(3) The sublimation transfer dyeing method according to (1) or (2), wherein the intermediate recording medium is cellulose-containing paper.
(4) The sublimation transfer dyeing method according to any of (1) to (3), wherein the intermediate recording medium is tracing paper.
(5) The sublimation transfer dyeing method according to any of (1) to (3), wherein the intermediate recording medium is glassine.
(6) The sublimation transfer dyeing method according to any of (1) to (3), wherein the intermediate recording medium is parchment.
(7) The sublimation transfer dyeing method according to any of (1) to (3), wherein the intermediate recording medium is paraffin paper or wax paper.
(8) The sublimation transfer dyeing method according to any of (1) to (3), wherein the intermediate recording medium is greaseproof paper.
(9) The sublimation transfer dyeing method according to any of (1) to (3), wherein the intermediate recording medium is condenser paper.
(10) The sublimation transfer dyeing method according to any of (1) to (3), wherein the intermediate recording medium is varnished paper.
(11) The sublimation transfer dyeing method according to (1), wherein the product to be dyed is selected from hydrophobic fiber or structures thereof, film or sheet comprised of hydrophobic resin, and cloth, glass, metal, or ceramic coated with hydrophobic resin.
(12) A dyed product dyed by the sublimation transfer dyeing method according to (1) or (11).
(13) An intermediate recording medium used in the sublimation transfer dyeing method according to (1), wherein the intermediate recording medium has a density of greater than 1.00 g/cm³, and to which a toner is attached by an electrophotographic process.

### Effect of the Invention

A sublimation transfer dyeing method that is capable of highly efficient dyeing of a product to be dyed by an electrophotographic process using a toner, and a dyed product dyed highly efficiently using the dyeing method could be provided by the present invention.

### Best Mode for Carrying Out the Invention

Any intermediate recording medium that can be used for sublimation transfer can be used as the intermediate recording medium provided that the density is greater than 1.00 g/cm³. Particularly preferable among these are varieties and processed products of paper and paperboard listed in “3. classification f) varieties and processed products of paper and paperboard” on pages 28 to 47 of “Paper, board and pulp—Vocabulary [JIS P 0001:1998 (confirmed in 2008, revised on Mar. 20, 1998, published by Japanese Industrial Standards Committee)]” (nos. 6001 to 6284; however excluding nos. 6235 “greaseproof,” 6263 “flute, stage,” 6273 “pulp molded products,” 6276 “carbon paper,” 6277 “multi-copy form paper,” and 6278 “back carbon form paper”) and cellophane (“varieties and processed products of paper and paperboard; and cellophane” is referred to hereinafter as “paper or the like”) is preferable.

“Cellophane” refers to cellophane listed in “3. classification b) packaging material 1) paper and paperboard-related,” no. 2009 in “Glossary of terms for packaging [JIS Z 0108:2005 (confirmed in 2009, revised on Jun. 20 2005, published by Japanese Standards Association)].”

The abovementioned paper or the like includes materials not containing cellulose and not usually being classified as paper. However, in the present specification, this kind of paper or the like also includes the sense of paper.

Examples of the aforementioned paper or the like include ivory board, asphalt paper, art paper, colored board, colored woodfree paper, ink jet printing paper, reclaimed printing paper, printing paper, printing paper grade A, printing paper grade B, printing paper grade C, printing paper grade D, India paper, printing tissue paper, Japanese tissue paper, back carbon paper, air mail paper, sanitary paper, embossed paper, OCR paper, offset printing paper, cardboard, chemical fiber paper, converting paper, gasen-shi, pattern paper, machine glazed kraft paper, wall paper base, thread paper base, paper string base, pressure sensitive copying paper, light sensitive paper, thermal recording paper, ganpi-shi, can board, yellow strawpaper, imitation leather paper, ticket paper, high performance paper, cast coated paper, kyohana-gami, Japanese vellum, metallized paper, metal foil paper, glassine, rotogravure paper, kraft paper, extensible kraft paper, kraft board, crepe paper, lightweight coated paper, cable insulating paper, saturating decorative paper, building material base, Kent paper, abrasive paper base, synthetic paper, synthetic fiber paper, coated paper, condenser paper, miscellaneous paper, woody paper, bleached kraft paper, diazo sensitized paper, paper tube base paper, magnetic recording paper, boxboard, dictionary paper, lightproof paper, heavy duty sack kraft paper, machine glazed paper, security paper, shoji-gami, woodfree paper, communication paper, base paper for food containers, book paper, shodo-yoshi, white lined board, white lined chipboard, newsprint, blotting paper, water-soluble paper, drawing paper, ribbed kraft paper, laid paper, speaker cone paper, electrostatic recording paper, sanitary paper and tissue paper, laminate base paper, gypsum liner board, adhesive paper base, printing paper grade B special, cement sack paper, ceramic paper, solid fiberboard, tar paper, tarpaulin paper, alkali-resistant paper, fire-resistant paper, acid-resistant paper, greaseproof paper, towel paper, dan-shi, corrugated fiberboard, liner and corrugating medium, map paper, chip board, wood containing paper, neutral paper, chiri-gami, matte art paper, tea bag paper, facial tissue, electrical insulating paper, tengujo, pasted paper, transfer paper, toilet tissue paper, tabulating card paper, duplicating base paper, coated printing paper, coating base paper, torinoko, tracing paper, corrugating medium, napkin paper, flame-resistant paper, NIP paper, tag paper, adhesive paper, carbonless copying paper, release paper, machine glazed brown wrapping paper, baryta paper, paraffin paper or wax paper, vulcanized fiber, han-shi, PPC paper, writing paper, ultra-lightweight coated printing paper, business form or continuous business form, manifold base paper, press board, moisture-proof paper, hosho-shi, waterproof paper, anti-rust paper, wrapping paper, bond paper, manila board, mino-gami or shoin-gami, milk carton board, simili paper, greased paper, yoshino-gami, rice paper, cigarette paper, liner or linerboard, parchment, unglazed kraft paper, roofing paper, filter paper, Japanese paper, varnished paper, mill wrapper, light-weight paper, air-dried paper, wet strength paper, ashless paper, acid free paper, paper or board without finish, two-layer paper or board, three-layer paper or board, multi-layer paper or board, unsized paper, sized paper, wove paper, veined paper or board, machine-finished paper or board, machine-glazed paper or board, plate-glazed paper or board, friction-glazed paper or board, calendered paper or board, super calendered paper or board, lamine (paper or board), one side colored paper or board, two sides colored paper or board, twin-wire paper or board, rag paper, all-rag paper, mechanical woodpulp paper or board, mixed straw pulp paper or board, water-finished paper or board, chipboard, lined chipboard, millboard, glazed millboard, solid board, mechanical pulp board, brown mechanical pulp board, brown mixed pulp board, leather fiber board, asbestos board, felt board, tarred brown paper, waterleaf paper, surface sized paper, presspahn, press paper, cockle finished paper, pasted ivory board, blade coated paper, roll coated paper, gravure coated paper, size press coated paper, brush coated paper, air knife coated paper, extrusion coated paper, dip coated paper, curtain coated paper, hot melt coated paper, solvent coated paper, emulsion coated paper, bubble coated paper, imitation art paper, bible paper, poster paper, wrapping tissue, base paper, carbon base paper, base paper for diazotype, photographic base paper, base paper for frozen foods: for direct contact paper, base paper for frozen foods: for non-contact paper, safety paper, banknote paper, insulating paper or board, paper for laminated insulators, insulating paper for cable, shoe board, paper for textile paper tubes, jacquard paper or board, board for pressing, bookbinding board, suitcase board, archival paper, record paper, kraft liner, tested liner, kraft faced liner, couverture ordinaire, envelope paper, folding boxboard, coated folding boxboard, bleached lined folding boxboard, typewriting paper, stencil duplicator copy paper, spirit duplicator copy paper, calender roll paper, ammunition cartridge paper, fluting paper, fluted paper, union paper, reinforced union paper, cloth-lined paper or board, cloth-centered paper or board, reinforced paper or board, pasted lined board, carton compact, facing, wet crepe, index card, carbonless copy form paper, correspondence envelope, postcard, illustrated postcard, lettercard, illustrated lettercard, and cellophane.

Any of these kinds of paper or the like can be used as the intermediate recording medium provided that the density is greater than 1.00 g/cm³.

As is described later, thermal treatment normally at about 190° C. to 210° C. is performed when performing sublimation transfer. Accordingly, the paper or the like having a density greater than 1.00 g/cm³ is preferably a kind that is stable during the thermal treatment.

The density can be measured by a method following “Testing method for thickness and density of paper and paperboard [JIS P 8118:1998(confirmed in 2010, revised on Nov. 20, 1998, published by Japanese Standards Association)].”

The aforementioned kinds of paper or the like are preferably given as examples for the intermediate recording medium having a density greater than 1.00 g/cm³. Cellulose-containing paper is more preferable. Tracing paper, glassine, parchment, paraffin paper or wax paper, greaseproof paper, condenser paper, varnished paper, and the like, are particularly preferably given as examples thereof. However, these kinds of paper or the like also include those having a density not greater than 1.00 g/cm³, and therefore the density is preferably measured following the aforementioned method.

The density of the intermediate recording medium is normally greater than 1.00 g/cm³, preferably greater than 1.00 g/cm³ to 2.00 g/cm³, more preferably greater than 1.00 g/cm³ to 1.80 g/cm³, even more preferably from 1.01 g/cm³ to 1.70 g/cm³, in some cases preferably from 1.02 g/cm³ to 1.60 g/cm³, and particularly preferably from 1.03 g/cm³ to 1.59 g/cm³.

The aforementioned tracing paper may be further subjected to special processing for the purpose of improving strength or transparency. Such processing includes methods that treat the tracing paper with fat, resin, or wax; and methods that mechanically treat the paper material in a preparation stage.

Tracing paper having undergone these kinds of processing also are preferable as the intermediate recording medium.

Most of the aforementioned glassine generally has high transparency and may be made opaque by adding filler, and any kind is useful as the intermediate recording medium. Glassine is generally required to have no pinholes and to have favorable resistance to grease, and therefore is often used for food packaging, container linings, or the like.

Any of such glassine is preferable as the intermediate recording medium.

The aforementioned parchment is often used for packaging of butter, cheese, meats, and the like, for reasons including that the parchment indicates a high resistance to penetration by organic liquids, particularly fat and grease; and that the parchment is imparted with a property of being able to withstand dissociation using boiling water, is tasteless and odorless, and is grease resistant and water resistant.

Such parchment also is preferably used as the intermediate recording medium.

The aforementioned paraffin paper or wax paper is produced by coating or impregnating glassine, simili paper, kraft paper, or the like, with a coating agent mainly containing paraffin. Any of such paraffin paper or wax paper is preferable as the intermediate recording medium.

“Greaseproof paper,” which is a general term of paper imparted with resistance to grease, indicates paper that was made using highly beaten chemical pulp and paper that was chemically treated and/or coated to have resistance to fats. Any of such greaseproof paper is preferable as the intermediate recording medium for sublimation transfer dyeing.

The aforementioned condenser paper is paper that is sandwiched between condenser paperboard for use as a dielectric, and is produced using kraft pulp, or the like, as a main raw material. Required performance includes that there be no pinholes; that the paper be chemically neutral; and that electrically harmful material, particularly conductive particles, be avoided to the extent possible.

Any of such condenser paper is preferable as the intermediate recording medium.

The aforementioned varnished paper is electrical insulating paper made by dissolving a resin in dry oil or boiled oil, thinning with turpentine oil, petroleum, or the like, and impregnating a base paper with the resulting solution. Any of such varnished paper is preferable as the intermediate recording medium.

A toner used in the aforementioned electrophotographic process at least contains a dye and a resin. The toner may furthermore contain a wax, a charge control agent, an external additive, or the like.

Any such toner can be used provided that, for example, the toner is a well-known toner used in sublimation transfer. A toner known as one for printing use is preferably used when a well-known toner is used.

A dye suitable for sublimation transfer can be selected as the aforementioned dye.

“Dye suitable for sublimation transfer” indicates a dye preferably of grade 3 to 4 or lower, more preferably grade 3 or lower, as a test result of thermosensitive treatment test (C test) dye (polyester) in “Test methods for color fastness to dry heat [JIS L 0879:2005] (confirmed in 2010, revised on Jan. 20, 2005, published by Japanese Standards Association).” The following dyes are given as examples of well-known dyes among such dyes.

Yellow dyes include C. I. Disperse Yellow 3, 7, 8, 23, 39, 51, 54, 60, 71, 86; and C. I. Solvent Yellow 114, 163.

Orange dyes include C. I. Disperse Orange 1, 1:1, 5, 20, 25, 25:1, 33, 56, 76.

Brown dyes include C. I. Disperse Brown 2.

Red dyes include C. I. Disperse Red 11, 50, 53, 55, 55:1, 59, 60, 65, 70, 75, 93, 146, 158, 190, 190:1, 207, 239, 240; and C. I. Vat Red 41.

Violet dyes include C. I. Disperse Violet 8, 17, 23, 27, 28, 29, 36, 57.

Blue dyes include C. I. Disperse Blue 19, 26, 26:1, 35, 55, 56, 58, 64, 64:1, 72, 72:1, 81, 81:1, 91, 95, 108, 131, 141, 145, 359, 360; and C. I. Solvent Blue 3, 63, 83, 105, 111.

Any of the aforementioned dyes may be used singly or in combinations of two or more kinds.

An example of a purpose for combining use of a dye is the preparation of a black toner. That is, a yellow dye and a red dye can be suitably mixed in a main component of a blue dye to tone a black color, and this can be used as a black dye. Also, for example, a plurality of dyes may be mixed for the purpose of finely adjusting the color tone of blue, yellow, orange, red, violet, black, or the like, to a more preferable color mixture.

The aforementioned resin is not particularly limited, and can be suitably selected from well-known resins in accordance with the purpose.

Examples include polymers of styrene or substitution products thereof, styrene copolymers, polymethyl methacrylate, polybutyl methacrylate, polyvinyl chloride, polyvinyl acetate, polyethylene, polypropylene, polyester, epoxy resins, epoxy polyol resins, polyurethane, polyamide, polyvinyl butyral, polyacrylate resins, rosin, modified rosin, terpene resins, aliphatic hydrocarbon resins, alicyclic hydrocarbon resins, aromatic petroleum resins, chlorinated, paraffin, and paraffin wax.

Any of the aforementioned resins may be used singly or in combinations of two or more kinds.

Examples of polymers of styrene or substitution products thereof include polystyrene, poly p-chlorostyrene, and polyvinyl toluene.

Examples of styrene copolymers include styrene-p-chlorostyrene copolymers, styrene-propylene copolymers, styrene-vinyl toluene copolymers, styrene-vinyl naphthalene copolymers, styrene-acrylate ester copolymers (styrene-methyl acrylate copolymers, styrene-ethyl acrylate copolymers, styrene-butyl acrylate copolymers, styrene-octyl acrylate copolymers, and the like), styrene-methacrylate ester copolymers (styrene-methyl methacrylate copolymers, styrene-ethyl methacrylate copolymers, styrene-butyl methacrylate copolymers, and the like), styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleate copolymers, and styrene-maleate ester copolymers.

Some of the aforementioned resins can be acquired as off-the-shelf products. Examples include Diacron® FC-2232, Diacron® FC-1224, and the like, manufactured by Mitsubishi Rayon Co., Ltd., as polyesters; and CPR-100, CPR-250, and the like, manufactured by Mitsui Chemicals Inc, as styrene-acrylate ester copolymers.

The aforementioned waxes are not particularly limited, and can be suitably selected from well-known waxes, but the wax is preferably a low-melting-point wax having a melting point of 50 to 120° C. By dispersing the low-melting-point wax in the aforementioned resin, the wax effectively works as a release agent between a fixing roller and a toner boundary, whereby a hot offset property is favorable even with an oil-less method (a method that does not apply a release agent, for example such as oil, on the fixing roller).

Examples of the waxes include carnauba wax, cotton wax, wood wax, rice wax, and other vegetable waxes; beeswax, lanolin, and other animal waxes; montan wax, ozokerite, selsyn, and other mineral waxes; paraffin, microcrystalline, petrolatum, and other petroleum waxes; and other natural waxes.

Additional examples include Fischer-Tropsch wax, polyethylene wax, and other synthetic hydrocarbon waxes; synthetic waxes including esters, ketones, and ethers; and other synthetic waxes.

Furthermore usable as waxes are 12-hydroxystearic acid amide, stearic acid amide, phthalic anhydride imide, chlorinated hydrocarbons, and other fatty acid amides; homopolymers or copolymers of poly-n-stearyl methacrylate, poly-n-lauryl methacrylate, and other acrylate (for example, copolymers of n-stearyl acrylate-ethyl methacrylate, and the like), low-molecular-weight crystalline polymer resins; and crystalline polymers having long alkyl groups on side chains.

Any of the aforementioned waxes may be used singly or in combinations of two or more kinds.

The melt viscosity of the wax is preferably 5 to 1000 cps, more preferably 10 to 100 cps, as a value measured at a temperature 20° C. higher than the melting point of the wax.

When the melt viscosity is less than 5 cps, the releasing property may degrade. When the melt viscosity is greater than 1000 cps, an improving effect on hot offset resistance and/or low-temperature fixing property may not be obtained.

Some of the aforementioned waxes can be acquired as off-the-shelf products. Examples include carnauba wax C1, and the like, manufactured by S. Kato & Co., as carnauba waxes; and Licowax KP, and the like, manufactured by Clariant International Ltd., as montan waxes.

The aforementioned charge control agent is not particularly limited, and can be suitably selected from well-known charge control agents.

Examples include nigrosine dyes, triphenylmethane dyes, chromium-containing metal complex dyes, molybdic acid chelate pigments, rhodamine dyes, alkoxyamines, quaternary ammonium salts (including fluorine-modified quaternary ammonium salts), alkylamides, phosphorus monomers and compounds thereof, tungsten monomers and compounds thereof, fluorine-based active agents, metal salts of salicylic acid, and metal salts of salicylic acid derivatives.

Any of the aforementioned charge control agents may be used singly or in combinations of two or more kinds.

Some of the aforementioned charge control agents can be acquired as off-the-shelf products. Examples include the nigrosine dye Bontron® O3, the quaternary ammonium salt Bontron® P-51, the metal-containing azo dye Bontron® S-34, the oxynaphthoate-based metal complex Bontron® E-82, the salicylate-based metal complex Bontron® E-84, and the phenolic condensate Bontron® E-89 (the above manufactured by Orient Chemical Industries Co., Ltd.); the molybdenum-quaternary ammonium salt complexes TP-302, TP-415 (the above manufactured by Hodogaya Chemical Co., Ltd.); the quaternary ammonium salt Copy Charge® PSY VP2038, the triphenylmethane derivative Copy Blue PR, and the quaternary ammonium salts Copy Charge® NEG VP2036 and Copy Charge® NX VP434 (the above manufactured by Hoechst AG); LRA-901 and the boron complex LR-147 (manufactured by Japan Carlit Co., Ltd.); copper phthalocyanine; perylene; quinacridone; azo pigments; or compounds based on polymers having sulfonic acid groups, carboxyl groups, tertiary ammonium salts, and other functional groups.

The aforementioned external additive can be used for the purpose of imparting fluidity, developing property, charging property, or the like, to the toner particles. The external additive is not particularly limited, and can be suitably selected from well-known external additives.

Specific examples of external additives include silica, alumina, titanium oxide, barium titanate, magnesium titanate, calcium titanate, strontium titanate, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride.

Any of the aforementioned external additives may be used singly or in combinations of two or more kinds.

The primary particle diameter of the external additive is preferably 5 nm to 2 μm, more preferably 5 nm to 500 nm. The specific surface area by BET method of the external additive is preferably 20 to 500 m²/g.

Some of the aforementioned external additives can be acquired as off-the-shelf products. Examples include AEROSIL® R812, AEROSIL® RX50, alumina AEROXIDE® Alu C 805, and the like, manufactured by Nippon Aerosil Co., Ltd., as silica; AEROXIDE® TiO₂ T805, AEROXIDE® TiO₂ NKT90, and the like, manufactured by Nippon Aerosil Co., Ltd., as titanium oxide; and SW-100, and the like, manufactured by Titan Kogyo Co., Ltd., as strontium titanate.

In the following, “parts” indicates parts by mass, and “%” indicates percent by mass, unless specifically stated otherwise.

The content of dye contained in the toner is not particularly limited, and can be suitably selected in accordance with the purpose. A standard of content of dye is normally 1 to 40%, preferably 2 to 35%, over the total mass of the toner.

When the content of dye is less than 1%, a decrease of shade depth is observed. When the content is greater than 40%, poor distribution of dye in the toner results, and this may lead to a degradation of electrical characteristics of the toner.

The content of resin contained in the toner is not particularly limited, and can be suitably selected in accordance with the purpose. A standard of content of resin is normally 60 to 99%, preferably 65 to 98%, over the total mass of the toner.

When the content of resin is less than 60%, poor distribution of dye in the toner results, and this may lead to a degradation of electrical characteristics of the toner. When the content is greater than 99%, a decrease of shade depth is observed.

The content of wax contained in the toner is not particularly limited, and can be suitably selected in accordance with the purpose. 0.1 to 20% is preferable, and 0.5 to 10% is more preferable.

When the content of wax is less than 0.1%, offset to the fixing roller results. When the content is greater than 20%, poor fixing to the intermediate recording medium is observed.

The content of charge control agent contained in the toner is not particularly limited, and can be suitably selected in accordance with the purpose. That content differs according to the kind of resin, the presence or absence of additives, the dispersion method, and the like, and it is difficult to prescribe generally. However, a standard of content of charge control agent is normally 0.1 to 10%, preferably 0.2 to 5%, over the total mass of the resin contained in the toner.

When the content of charge control agent is less than 0.1%, controllability of charge may not be obtained. When the content is greater than 10%, the charging property of the toner becomes excessively great, the effect of the charge control agent fades, the static attraction force with the development roller increases, and this may lead to lowering of fluidity of the toner and lowering of image density.

The content of external additive contained in the toner is not particularly limited, and can be suitably selected in accordance with the purpose. A standard of content of external additive is normally 0.01 to 5.0%, preferably 0.01 to 4.0%, over the total mass of the toner.

A method for producing the toner is described.

Methods for producing toners include pulverization methods that produce toners through steps of kneading, pulverization, and grading, as well as methods for producing polymer toners by polymerizing a polymerizable monomer, and forming particles while simultaneously controlling the shape and size (for example, emulsification polymerization method, solution suspension method, emulsification association method, polyester extension method, and the like). A pulverization method is preferable by the feature that production can be accomplished at high speed. A method for producing a toner by pulverization method generally includes the following three production steps 1 to 3.

[Production step 1]

A step in which a dye, resin, as well as a charge control agent, wax, and the like, as needed, are mixed in a Henschel mixer or other mixer to obtain a dye-resin mixture.

[Production step 2]

A step in which the dye-resin mixture is melted and kneaded in a sealed kneader, a uniaxial or biaxial extruder, or the like, and cooled to obtain a resin composition.

[Production step 3]

A step in which the resin composition is coarsely pulverized in a hammer mill, or the like, then finely pulverized in a jet mill, or the like, and graded to an objective particle size distribution using a cyclone as needed, to obtain toner (toner particles).

Also preferable is a “production step 4” in which the aforementioned external additives are added, as needed, to the toner obtained in the production step 3 and mixed in a Henschel mixer, or the like, thereby obtaining the toner containing the external additives.

The toner produced in the aforementioned manner can be used as a magnetic or non-magnetic single-ingredient developer, but can also be mixed with a carrier to be used as a two-ingredient developer.

Usable carriers include magnetic particles containing iron, ferrite, magnetite, and other metals; alloys of these metals with aluminum, lead, and the like; and other well-known materials, but ferrite particles are particularly preferable. Coated carriers in which the surfaces of magnetic particles are coated with a binding resin or other coating agent, or binder-type carriers in which a magnetic micropowder is dispersed in a binding resin, or the like, also may be used.

In an electrophotographic process using a toner, an image is printed on an intermediate recording medium generally by the following operations (1) to (3).
(1) An electrostatic latent image formed by exposure on a photosensitive drum or other latent image carrier is developed using a developer using a toner, and a toner image is formed.
(2) The obtained toner image is transferred onto paper or other intermediate recording medium using a transfer member, whereby a toner image is formed on the intermediate recording medium.
(3) The obtained intermediate recording medium is heated and pressurized using a fixing device, and the toner image formed on the intermediate recording medium is fixed to the intermediate recording medium. Printing of the image on the intermediate recording medium is completed thereby.

The fixing device is generally one that heats and pressurizes while pinching paper with a pair of rollers equipped with a heater and conveying the paper by rotation of the roller, but the fixing device is not limited to this. The rollers are heated normally to a surface temperature of about 80 to 170° C. by the heater.

The fixing unit may also be one that is provided with a cleaning function. Cleaning methods include a method that supplies silicone oil to the rollers to perform cleaning; and a method that cleans the rollers with a pad, roller, web, or the like, impregnated with silicone oil.

An example of a sublimation transfer dyeing method is a dyeing method in which a toner is attached to the intermediate recording medium, for example, by an electrophotographic process, to form a toner image, the toner-attached surface of the intermediate recording medium is then overlaid with a product to be dyed, and thermal treatment is performed normally at about 190 to 210° C., whereby the dye in the toner is transferred from the intermediate recording medium to the product to be dyed, and the toner image on the intermediate recording medium is sublimation-transferred to the product to be dyed.

Examples of the products to be dyed include hydrophobic fiber typified by polyester (or cloth, being a structure thereof); film or sheet comprised of hydrophobic resin, typified by PET films or PET sheets; and cloth, glass, metal, or ceramic coated with hydrophobic resin.

An intermediate recording medium used in the sublimation transfer dyeing method, wherein a density is greater than 1.00 g/cm³, and a toner is attached by an electrophotographic process, also is included in the scope of the present invention. “Density” of the intermediate recording medium indicates, as previously mentioned, the density of the intermediate recording medium before the toner is attached.

Because the dye in the toner attached to the intermediate recording medium can be sublimation-transferred to the product to be dyed by using the sublimation transfer dyeing method, a dyed product having a higher shade depth can be obtained with a smaller amount of toner.

Also because the amount of toner needed to dye the product to be dyed can be smaller, the cost required for dyeing can be smaller a dyeing method excellent in cost benefit can be provided.

Furthermore because the amount of dye remaining on the intermediate recording medium after sublimation transfer becomes much smaller, the intermediate recording medium after sublimation transfer dyeing, which normally could not be cleaned of the dye and had to be discarded by incineration, or the like, can be recycled as regenerated paper or the like, and this is promising also as an environmentally-friendly dyeing method.

### EXAMPLES

The present invention is described in further detail below using examples, but the present invention is not limited to these examples. In the examples, “parts” indicates parts by mass, and “%” indicates percent by mass, unless specifically stated otherwise.

In the test examples, average particle diameter was measured using a “Multisizer® 3 (manufactured by Beckman Coulter Inc.)” precision particle size measurement apparatus.

[Toner preparation example 1]
(Step 1)

Diacron® FC-1224 (100 parts), Kayaset Red B (manufactured by Nippon Kayaku Co., Ltd., C. I. Disperse Red 60:10 parts), Bontron® E-84 (1 part), and Licowax® KP (4 parts) were put into a Henschel mixer and premixed for 10 minutes at a rotation speed of 30 m/second, and the mixture was then melted and kneaded using a biaxial extruder. The obtained melted and kneaded product was pulverized and graded using a pulverizing and grading machine, whereby particles having an average particle diameter of 8.4 μm were obtained.
(Step 2)

The particles obtained in the toner preparation example 1 (step 1) (100 parts), AEROSIL® R812 (1 part), AEROSIL® RX50 (1 part), and SW-100 (1 part) were put into a Henschel mixer and agitated for 10 minutes at a rotation speed of 30 m/second, and a magenta toner was obtained.

(Setting of printer and printing conditions for causing toner to attaching to intermediate recording medium)
(Printer setting example 1)

Pure toner inside a toner cartridge (Magenta) of an electrophotographic printer “Satera® LBP5910” (manufactured by Canon Inc.) was removed and the magenta toner obtained in preparation example 1 (step 2) was put therein.

A table with document size: A4, resolution: 600 pixels/inch, and mode: RGB color was next created using “Adobe® Photoshop 7.0” image processing software manufactured by Adobe Systems Inc., image data of R: 255, G: 0, and B: 255 (magenta toner 100% output A4 solid pattern) was created so that the printing output of magenta toner was 100%, and 200 copies of the 100% output A4 solid pattern were printed under the printing conditions listed in Table 1 below. The pure toner remaining in the drum cartridge was replaced with the magenta toner obtained in the toner preparation example 1 (step 2), and a printer for attaching toner to an intermediate recording medium was set.

TABLE 1

| Printing quality: | User setting |
|---|---|
| Printing purpose | General |
| Color mode: | Color |
| Color setting: | Perform |
| Position after adjustment: | X: 0 |
| | Y: 0 |
| Brightness: | ◯ (Standard) |
| Contrast: | ◯ (Standard) |
| Image: | Take as object |
| Graphics: | Take as object |
| Text: | Take as object |
| Matching mode: | Device correction mode |
| Prefer color matching of application: | No |
| Image: | |
| Matching method: | To vivid color |
| Setting of monitor scanner: | sRGB v.1.31 (Canon) |
| Graphics: | |
| Matching method: | To vivid color |
| Setting of monitor scanner: | sRGB v.1.31 (Canon) |
| Text: | |
| Matching method: | To vivid color |
| Setting of monitor scanner: | sRGB v.1.31 (Canon) |
| Gamma correction: | 1 |
| CanoFine: | Do not use |
| Mode detail: | High quality |
| Resolution: | Fine (600 dpi) |
| Gray scale: | Panel preference |
| Half tone: | Panel preference |
| Draft mode: | Do not use |
| Advanced smoothing: | Panel preference |
| Line processing: | Panel preference |
| TypeWing function: | Use |
| Image acceleration processing: | Minimum |
| Compressed image data processing: | Automatic |
| Toner concentration | Panel preference |
| Gray compensation: | All |
| Print with preference for colored | No |
| lines or characters: | |
| Gradation smoothing: | Do not use |

(Printing conditions setting example 1)

A table with document size: A4, resolution: 600 pixels/inch, and mode: RGB color was created using “Adobe Photoshop 7.0” image processing software (manufactured by Adobe Systems Inc.), RGB mixed data was input with the conditions listed in Table 2 below, test patterns were created in 5% intervals from printing output 0% to 100%, and the printing conditions were set.

TABLE 2

| Printing output (%) | R | G | B |
|---|---|---|---|
| 100 | 255 | 0 | 255 |
| 95 | 255 | 13 | 255 |
| 90 | 255 | 26 | 255 |
| 85 | 255 | 38 | 255 |
| 80 | 255 | 51 | 255 |
| 75 | 255 | 64 | 255 |
| 70 | 255 | 77 | 255 |
| 65 | 255 | 89 | 255 |
| 60 | 255 | 102 | 255 |
| 55 | 255 | 115 | 255 |
| 50 | 255 | 128 | 255 |
| 45 | 255 | 140 | 255 |
| 40 | 255 | 153 | 255 |
| 35 | 255 | 166 | 255 |
| 30 | 255 | 179 | 255 |
| 25 | 255 | 191 | 255 |
| 20 | 255 | 204 | 255 |
| 15 | 255 | 217 | 255 |
| 10 | 255 | 230 | 255 |
| 5 | 255 | 242 | 255 |
| 0 | 255 | 255 | 255 |

### Example 1

Printing was performed with the printing conditions set in the aforementioned printing conditions setting example 1, using the printer set in the aforementioned printer setting example 1, on tracing paper(manufactured by Kokuyo Co., Ltd., tracing paper A4 heavyweight 75 g/m²) having a density of 1.09 g/cm³ as an intermediate recording medium, and an intermediate recording medium having toner attached was obtained.

The toner-attached surface of the obtained intermediate recording medium was overlaid with satin (basis weight 90 g/m²) composed of 100% polyester fiber, and thermal treatment was then performed with conditions of 195° C.×60 seconds using a heat press machine (manufactured by Taiyo Seiki Co., Ltd., transfer press machine TP-600A2), whereby a dyed product of the satin being dyed by the sublimation transfer dyeing method of the present invention was obtained.

### Comparative Example 1

The same as in example 1 was carried out, except that PPC paper (manufactured by Ricoh Co., Ltd., TP PAPER A4) having a density of 0.77 g/cm³ was used as an intermediate recording medium instead of the tracing paper used in example 1, and a dyed product of satin for comparison was obtained.

### Comparative Example 2

The same as in example 1 was carried out, except that coated paper (manufactured by Seiko Epson Corporation, coated paper) having a density of 1.00 g/cm³ was used as an intermediate recording medium instead of the tracing paper used in example 1, and a dyed product of satin for comparison was obtained.

### Comparative Example 3

The same as in example 1 was carried out, except that glossy paper (manufactured by Kokuyo Co., Ltd., glossy paper) having a density of 0.89 g/cm³ was used as an intermediate recording medium instead of the tracing paper used in example 1, and a dyed product of satin for comparison was obtained.

[(A) Shade depth test]

The shade depth of magenta color in the portions corresponding to each percent printing output were measured using a “SpectroEye” (manufactured by Gretag-Macbeth GmbH) spectrophotometer with respect to each dyed product obtained in example 1 and comparative examples 1 to 3. The results are listed in Table 3 below.

TABLE 3

| | Shade depth | | | |
|---|---|---|---|---|
| Printing | | Comparative | Comparative | Comparative |
| output (%) | Example 1 | Example 1 | Example 2 | Example 3 |
| 100 | 1.25 | 1.20 | 1.24 | 1.23 |
| 95 | 1.24 | 1.17 | 1.20 | 1.22 |
| 90 | 1.23 | 1.15 | 1.18 | 1.20 |
| 85 | 1.23 | 1.14 | 1.17 | 1.18 |
| 80 | 1.22 | 1.13 | 1.16 | 1.17 |
| 75 | 1.22 | 1.12 | 1.15 | 1.16 |
| 70 | 1.21 | 1.11 | 1.13 | 1.14 |
| 65 | 1.20 | 1.10 | 1.12 | 1.13 |
| 60 | 1.19 | 1.09 | 1.11 | 1.12 |
| 55 | 1.17 | 1.08 | 1.09 | 1.09 |
| 50 | 1.14 | 1.04 | 1.05 | 1.05 |
| 45 | 1.11 | 1.02 | 1.02 | 1.01 |
| 40 | 1.05 | 0.97 | 0.97 | 0.96 |
| 35 | 0.98 | 0.91 | 0.90 | 0.90 |
| 30 | 0.89 | 0.85 | 0.82 | 0.84 |
| 25 | 0.81 | 0.76 | 0.78 | 0.76 |
| 20 | 0.69 | 0.65 | 0.64 | 0.66 |
| 15 | 0.59 | 0.55 | 0.55 | 0.57 |
| 10 | 0.45 | 0.42 | 0.42 | 0.45 |
| 5 | 0.28 | 0.26 | 0.28 | 0.32 |
| 0 | 0.09 | 0.09 | 0.09 | 0.10 |

As is clear from the results in Table 3, the percent printing output until the shade depth of the dyed product of example 1 reached 1.20 or higher is lower than each comparative example. This means that a dyed product having a high concentration is obtained with a smaller amount of toner. A shade depth of 1.20 or higher is a practically sufficient depth for using textile printing.

Accordingly, it was confirmed that the sublimation transfer dyeing method of the present invention is capable of sublimation-transferring a dye contained in a toner attached to an intermediate recording medium, with good efficiency and with a high shade depth by an electrophotographic process.

### INDUSTRIAL APPLICABILITY

In the sublimation transfer dyeing method of the present invention, because the dye contained in the toner can be efficiently sublimation-transferred to the dyed product, a dyed product having a high shade depth with a smaller amount of toner can be obtained. Accordingly, the sublimation transfer dyeing method is very ideal as a sublimation transfer dyeing method by an electrophotographic process using a toner.

1. A sublimation transfer dyeing method comprising:
attaching a toner to an intermediate recording medium using an electrophotographic process and
sublimation-transferring, to a product to be dyed, a dye contained in the toner attached to the intermediate recording medium,
wherein an intermediate recording medium having a density greater than 1.00 g/cm³ is used as the intermediate recording medium.

2. The sublimation transfer dyeing method according to claim 1, wherein the intermediate recording medium is paper selected from the group consisting of paper listed in JIS P 0001:1998 3. classification f) varieties and processed products of paper and paperboard; and cellophane listed in JIS Z 0108:2005 3. classification b) packaging material 1) paper and paperboard-related.

3. The sublimation transfer dyeing method according to claim 1, wherein the intermediate recording medium is cellulose-containing paper.

4. The sublimation transfer dyeing method according to claim 1, wherein the intermediate recording medium is tracing paper.

5. The sublimation transfer dyeing method according to claim 1, wherein the intermediate recording medium is glassine.

6. The sublimation transfer dyeing method according to claim 1, wherein the intermediate recording medium is parchment.

7. The sublimation transfer dyeing method according to claim 1, wherein the intermediate recording medium is paraffin paper or wax paper.

8. The sublimation transfer dyeing method according to claim 1, wherein the intermediate recording medium is greaseproof paper.

9. The sublimation transfer dyeing method according to claim 1, wherein the intermediate recording medium is condenser paper.

10. The sublimation transfer dyeing method according to claim 1, wherein the intermediate recording medium is varnished paper.

11. The sublimation transfer dyeing method according to claim 1, wherein the product to be dyed is selected from hydrophobic fiber or structures thereof, film or sheet comprised of hydrophobic resin, and textiles, glass, metal, or ceramic coated with hydrophobic resin.

12. A dyed product dyed by the sublimation transfer dyeing method according to claim 1.

13. An intermediate recording medium used in the sublimation transfer dyeing method according to claim 1, wherein the intermediate recording medium has a density of greater than 1.00 g/cm³, and to which a toner is attached by an electrophotographic process.

14. A dyed product dyed by the sublimation transfer dyeing method according to claim 11.
